(19) United States
(12) Patent Application Publication
(10) Pub. No.: US 2010/0011409 A1
(43) Pub. Date: Jan. 14, 2010

(54) NON-INTERACTIVE INFORMATION CARD TOKEN GENERATION

(75) Inventors: Andrew A. Hodgkinson, Pleasant Grove, UT (US); Dale Olds, Draper, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/170,384

(22) Filed: Jul. 9, 2008

(51) Int. Cl. G06F 17/00; G06F 1/00

(52) U.S. Cl. 726/1; 726/9; 726/5

(57) ABSTRACT

Systems and methods for automatic, non-interactive generation of information card tokens are provided. An apparatus can include a receiver, a transmitter, and an information card token generator, wherein the information card token generator is operable to generate an information card token in response to an information card token request received from a relying party site, the information card security token being based at least in part on a user-defined policy.

### RELATED APPLICATION DATA

This application is related to co-pending and commonly owned U.S. application Ser. Nos. 11/843,572, 11/843,638, 11/843,640, 11/843,608, and 11/843,591, all of which were filed on Aug. 22, 2007, and claim the benefit of U.S. Application Ser. Nos. 60/895,312, 60/895,316, and 60/895,325, all of which were filed on Mar. 16, 2007; and is related to co-pending and commonly owned U.S. application Ser. No. 12/019,104, filed on Jan. 24, 2008, which claims the benefit of U.S. Application Ser. No. 60/973,679, filed on Sep. 19, 2007; and is related to co-pending and commonly owned U.S. application Ser. No. 12/038,674, filed on Feb. 27, 2008; and is related to co-pending and commonly owned U.S. application Ser. No. 12/044,816, filed on Mar. 7, 2008. All of the foregoing applications are hereby incorporated by reference herein.

### TECHNICAL FIELD

This disclosed technology pertains to the generation of information card tokens, and more particularly to systems and methods for the automated, non-interactive generation of such information card tokens.

### BACKGROUND

When a user interacts with “service providers” or “relying parties” (e.g., sites on the Internet), the service provider often expects to know something about the user that is requesting the services of the provider. The typical approach for a service provider is to require the user to log into or authenticate to the service provider's computer system. But this approach, while satisfactory for the service provider, is less than ideal for the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) It is estimated that an average user has over 100 accounts on the Internet. For users, this is becoming an increasingly frustrating problem to deal with. Passwords and account names are too hard to remember. Second, the user has no control over how the service provider uses the information it stores. If the service provider uses the stored information in a way the user does not want, the user has relatively little ability to prevent such abuse, and essentially no recourse after the fact.

In the past few years, the networking industry has developed the concept of information cards to tackle these problems. Information cards are a very familiar metaphor for users and the idea is gaining rapid momentum. Information cards allow users to manage their identity information and control how it is released. This gives users greater convenience in organizing their multiple personae, their preferences, and their relationships with vendors and identity providers. Interactions with on-line vendors are greatly simplified.

There are currently two kinds of information cards: 1) personal cards (or self-issued cards), and 2) managed cards (or cards that are issued by an identity provider). A personal card contains self-asserted identity information—that is, the person issues the card and is the authority for the identity information it contains. The managed card is issued by an identity provider. The identity provider provides the identity information and asserts its validity.

When a user wants to release identity information to a relying party (e.g., a web site that the user is interacting with), a tool known as a card selector (or identity selector) can assist the user in selecting an appropriate information card. When a managed card is selected, the card selector communicates with the identity provider to obtain a security token that contains the needed information. This interaction between the card selector and the identity provider is usually secure. The identity provider typically requests the user to authenticate himself or herself (e.g., using a username/password, X.509 certificate, etc.) before it will return a security token.

Much of the research, design, and implementation related to current information card technologies (e.g., Windows CardSpace) has centered around what has been termed the “user experience.” Specifically, much effort has gone into designing user-interactive (e.g., dialogue-based) interfaces in an attempt to greatly reduce the possibility that a user will inadvertently disclose their identity to an unintended third party. This often includes a secure desktop environment that mandates user interaction (e.g., using a keyboard and/or mouse to select an “Information Card” icon) in order to request and release security tokens. For example, if a username/password combination (a common type of credential for an information card) is required to authenticate to the provider, the card selector will generally prompt the user (e.g., through a pop-up window in the GUI) to explicitly select information from a set of optional claims to send to a relying party before releasing a security token to the relying party site. As an additional example, the Windows CardSpace GetToken API is always user-interactive in that it always requires user interaction in selecting an information card.

User-interactive card selectors have several shortcomings that call for a more streamlined (e.g., non-interactive) approach. It would be desirably advantageous for a user to be provided with a streamlined authentication to an information card-enabled site or service rather than requiring the user to select an information card and approve the release of a token every time. Users typically do not want to be frequently prompted by a card selector. In fact, a user will often “click without thinking”—that is, not pay attention to what information he or she is submitting—which can lead to undesirable results such as increased errors and even security risks.

Furthermore, in order to ensure that an information card system is secure and performs as expected from one release to the next, an unreasonable burden is placed on developers and quality assurance engineers who must perform regression testing. Given that there are a multitude of identity providers, token services, relying parties, and card types, testing even a small number of permutations via a manual “point-and-click” process can require an undesirably large amount of time.

A need remains for a way to address these and other problems associated with the prior art.

### SUMMARY

Embodiments of the disclosed technology pertain to the generation of information card tokens. This invention provides various techniques for automated, non-interactive (e.g., policy-based) generation of information card tokens for automated authentication and identity attribute disclosure. For example, an automated, policy-based scripting technique can provide a user with dynamic generation of information card tokens (e.g., in response to token requests) using information specified in a policy configuration file without requiring a user to interact with a card selector.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a prior art sequence of communications between a client, a relying party, and an identity provider.

FIG. 2 shows an exemplary information card having a credential.

FIG. 3 shows an exemplary embodiment of the disclosed technology implementing a security token generation capability.

FIG. 4 shows an exemplary embodiment of the disclosed technology operable to provide a user with policy configuration management capabilities.

FIGS. 5A-5B show a flowchart of an exemplary procedure to generate a security token according to embodiments of the disclosed technology.

FIG. 6 shows a flowchart of an exemplary procedure to manage a policy according to embodiments of the disclosed technology.

### DETAILED DESCRIPTION

A positive user experience is critical to the success of any technology. Current information card selectors are undesirably intrusive and inconvenient. Non-interactive, automated (e.g., policy-based) approaches to the release of identity information, as described herein, allow a user to still control the dissemination of data, but without the constant “in-your-face” presentation of card selector. For example, a policy can be set up for a user such that, when the user accesses a particular webpage, the authentication material is automatically presented (e.g., an appropriate information card is automatically provided) without any prompting of the user.

In an ideal world, all authentication and identity disclosures would be user-interactive. However, we operate in a world where automation is a necessity. If every server reboot, for example, required an administrator to interactively enter all credentials necessary to re-start protected services (e.g., database servers), the typical data center would quickly become unmanageable. Also, because routine backups (e.g., using Rsync over SSH) are often scheduled for times late at night when no users are around, it is imperative that such backups not require a user to be present at the interface to tend to a pop-up window requesting authentication-related information.

In addition, it is very important to extensively test any software that is meant to verify a user's identity prior to releasing updates. Traditional, user-interactive information card selectors severely limit the quantity (and quality) of testing that can be performed. Thus, non-interactive solutions such as the techniques described herein allow for the appropriate level of testing to be achieved.

Furthermore, a traditional, user-interactive card selector is too unwieldy to validate the interoperability of even a small number of identity providers, token services, and relying parties. The non-interactive solutions described herein allow for advantageous scripting of interoperability validation.

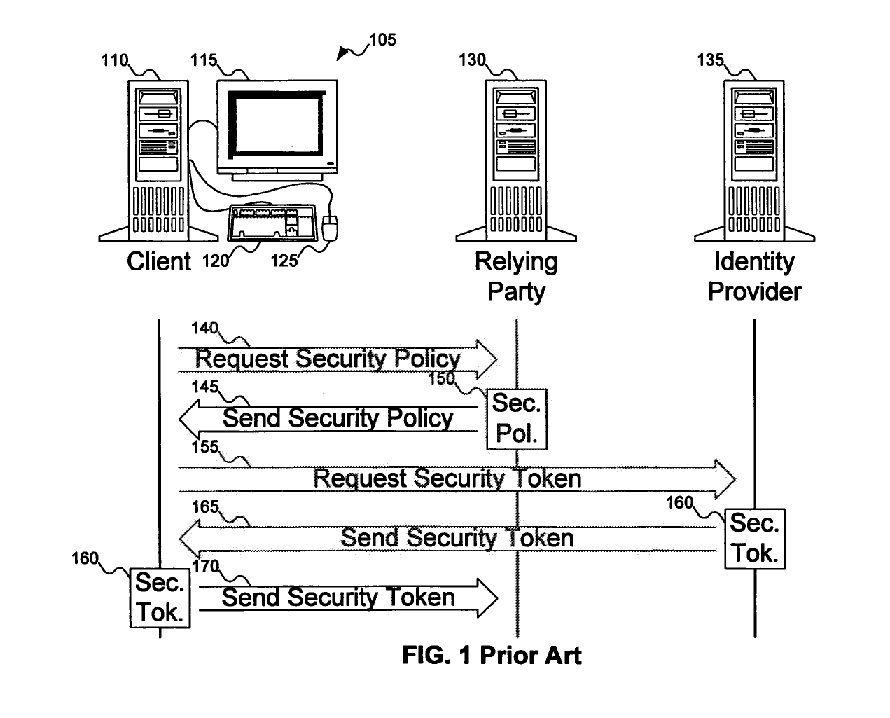

Before describing embodiments of the invention, however, it is important to understand the context of the invention. FIG. 1 shows a prior art sequence of communications between a client, a relying party, and an identity provider. For simplicity, each party (the client, the relying party, and the identity provider) may be referred to by their machines. Actions attributed to each party are taken by that party's machine, except where the context indicates the actions are taken by the actual party.

In FIG. 1, a computer system 105, the client, is shown as including a computer 110, a monitor 115, a keyboard 120, and a mouse 125. A person skilled in the art will recognize that other components (e.g., other input/output devices, such as a printer) can be included with the computer system 105. In addition, FIG. 1 does not show some of the conventional internal components (e.g., a central processing unit and memory) of computer system 105. A person skilled in the art will recognize that the computer system 105 can interact with other computer systems, such as a relying party 130 and a identity provider 135, either directly or indirectly, such as over a network (not shown). Finally, although FIG. 1 shows the computer system 105 as a conventional desktop computer, a person skilled in the art will recognize that the computer system 105 can be any type of machine or computing device capable of providing the services attributed herein to the computer system 105, such as a laptop computer, a personal digital assistant (PDA), or a cellular telephone, for example.

The relying party 130 is a machine managed by a party that relies in some way on the identity of the user of the computer system 105. The operator of the relying party 130 can be any type of relying party. For example, the operator of the relying party 130 can be a merchant running a business on a website. Alternatively, the operator of the relying party 130 can be an entity that offers assistance on some matter to registered parties. The relying party 130 is so named because it relies on establishing some identifying information about the user.

The identity provider 135, on the other hand, is typically managed by a party responsible for providing identity information (or other such information) about the user for consumption by the relying party 130. Depending on the type of information the identity provider 135 stores for a user, a single user might store identifying information with a number of different identity providers, any of which might be able to satisfy the request of the relying party 130. For example, the identity provider 135 might be a governmental agency, responsible for storing information generated by the government, such as a driver's license number or a social security number. Alternatively, the identity provider 135 might be a third party that is in the business of managing identity information on behalf of users.

The conventional methodology of releasing identity information can be found in a number of sources. One such source is Microsoft Corporation, which has published a document entitled Introducing Windows CardSpace, which can be found on the World Wide Web at http://msdn2.microsoft.com/en-us/library/aa480189.aspx and is hereby incorporated by reference. To summarize the operation of Windows CardSpace, when a user wants to access some data from the relying party 130, the computer system 105 can request a security policy from the relying party 130, as shown in a communication 140, which is returned in a separate communication 145 as a security policy 150. The security policy 150 is typically a summary of the information the relying party 130 needs, how the information should be formatted, etc.

Once the computer system 105 receives the security policy 150, the computer system 105 can identify which information cards will satisfy security policy 150. Different security policies might result in different information cards being usable. For example, if the relying party 130 simply needs a username and password combination, the information cards that will satisfy this security policy will typically be different from the information cards that satisfy a security policy requesting the user's full name, mailing address, and social security number. The user can then select an information card that satisfies security policy 150.

A prior art card selector (not shown) on the computer system 105 can be used by the user to select an information card. The card selector may present the user with a list or graphical display of all available information cards, and information cards that satisfy the security policy may be highlighted in some way to distinguish them from the remaining cards. Alternatively, the card selector may display only the information cards that will satisfy the security policy. The card selector may provide a means for the user to select the desired information card by, for instance, a mouse click or a touch on a touch screen.

Once the user has selected an acceptable information card, the computer system 105 can use the information card to transmit a request for a security token to the identity provider 135, as shown in a communication 155. This request can identify the data to be included in the security token, the credential that identifies the user, and other data the identity provider needs to generate the security token. The identity provider 135 returns a security token 160, as shown in a communication 165. The security token 160 can include a number of claims (e.g., pieces of information) that include the data the user wants to release to the relying party. The security token 160 is usually encrypted in some manner, and perhaps signed and/or time-stamped by the identity provider 135, so that the relying party 130 can be certain that the security token originated with the identity provider 135 (as opposed to being spoofed by someone intent on defrauding the relying party 130). The computer system 105 can then forward the security token 160 to the relying party 130, as shown in a communication 170.

In addition, the selected information card can be a self-issued information card (or personal card)—that is, an information card issued not by an identity provider, but by the computer system 105 itself. In that case, the identity provider 135 effectively becomes part of the computer system 105.

A person skilled in the art will recognize that because all pertinent information flows through the computer system 105, the user has a measure of control over the release of the user's identity information. The relying party 130 only receives the information the user wants the relying party 130 to have, and does not store that information on behalf of the user (although it would be possible for the relying party 130 to store the information in the security token 160 as there is no effective way to prevent such an act).

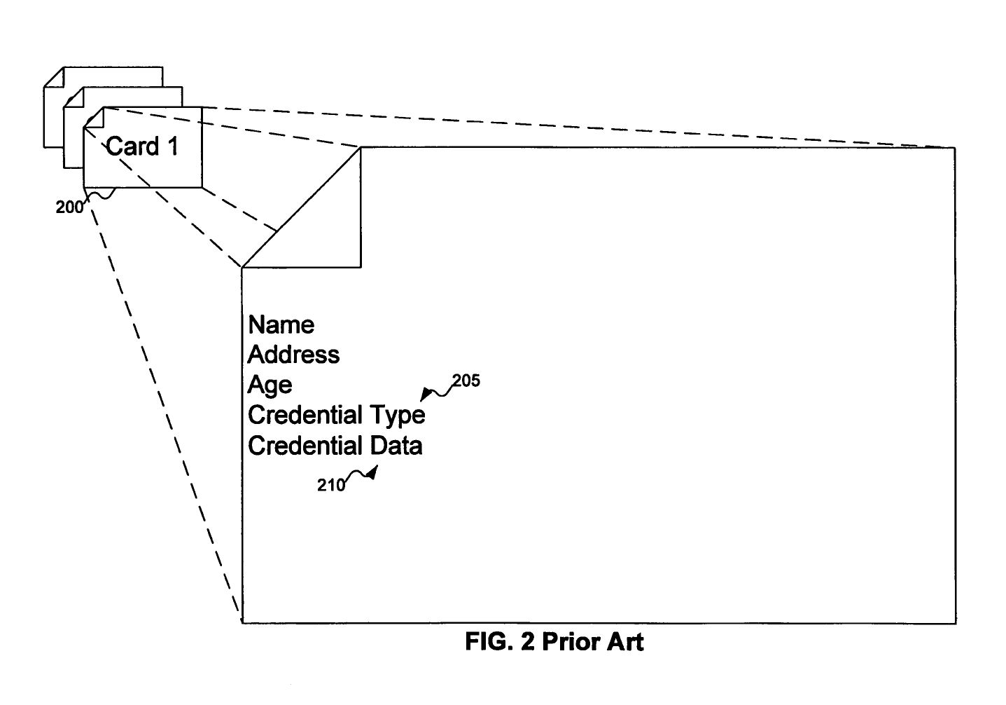

FIG. 2 shows an exemplary information card 200 having a credential. The information card 200 is shown as including the user's name, address, age, and credential. In particular, the information card 200 includes a credential type 205 and credential data 210. The credential type 205 can be any credential type associated with information cards such as username/password, X.509 certificate, and personal card, for example. The credential data 210 can include information that is specific to the credential type 205 of the information card 200. For example, if the credential type 205 of the information card 200 is username/password, the credential data 210 can include a username and a password. If the credential type 205 of the information card 200 is personal card, the credential data 210 can include a PPID of the personal card calculated with respect to the identity provider 135 of FIG. 1. A person skilled in the art will recognize that the credential type 205 can include other types of credentials and that the credential data 210 can include information that is specific to these other types of credentials. Although the information card 200 is shown as including the user's name, address, age, and credential, information cards can include many other types of information, such as driver's license number, social security number, etc.

Where the information card 200 is a managed information card (e.g., managed by the identity provider 135 of FIG. 1), the information represented by the information card 200 is typically not stored on the user's computer. Rather, this information is typically stored by the identity provider 135. Thus, the information displayed on the information card 200 would not be the actual information stored by the computer system 105 of FIG. 1, but rather an indicator of what information is included in the information card 200.

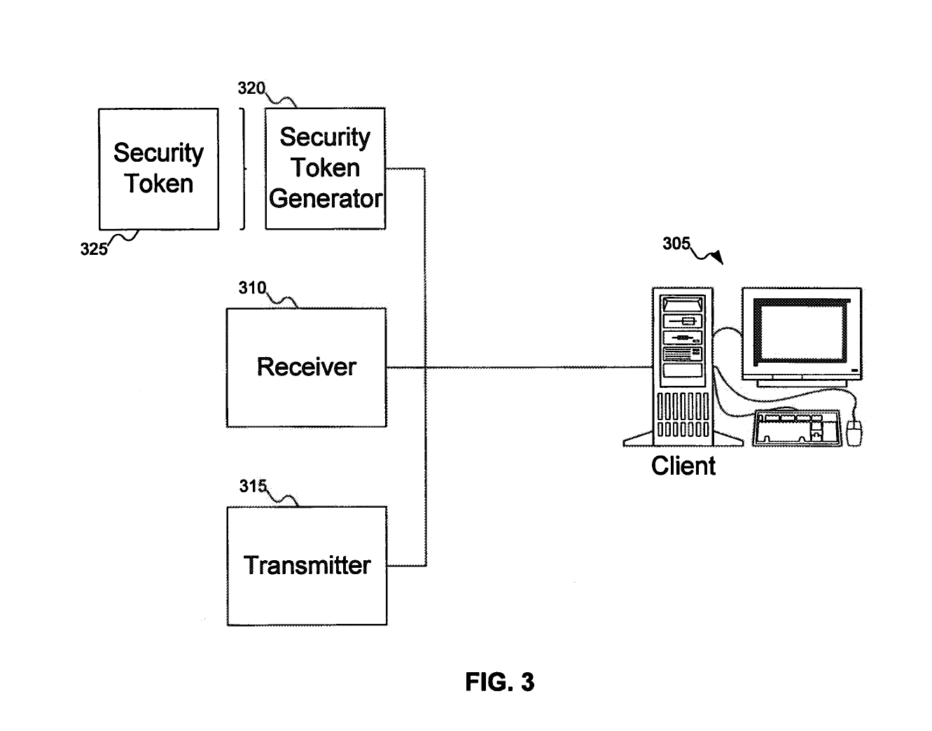

FIG. 3 shows an exemplary embodiment of the disclosed technology implementing a security token generation capability. A client computer system 305 includes a receiver 310, a transmitter 315, and a token generator 320. The receiver 310 can receive data transmitted to the client computer system 305, and the transmitter 315 can transmit information from the client computer system 305. The receiver 310 and the transmitter 315 can facilitate communications between the client 305 and, for example, a relying party (e.g., the relying party 130 of FIG. 1) and/or an identity provider (e.g., the identity provider 135 of FIG. 1), among other possibilities.

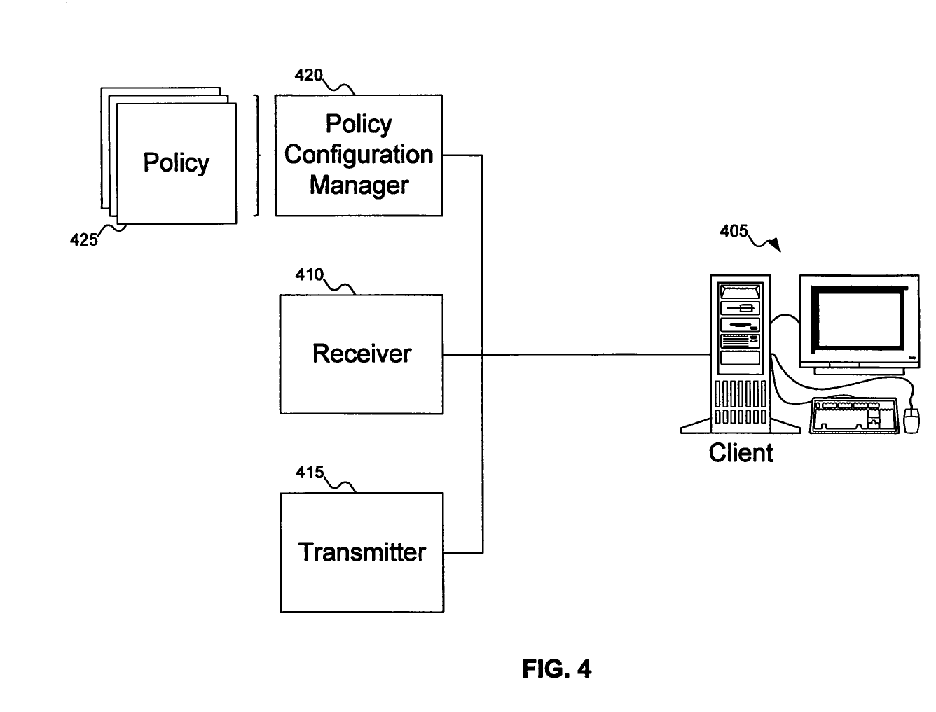

The token generator 320 can be implemented as a policy-based service running on the client 305 that can automatically generate a security token 325 on demand when requested without requiring any user interaction (e.g., without prompting the user for any card selection information). The token generator 320 can be set to run in the background on the client 305 to further minimize any interruption to the user. Generation of the security token 325 is desirably based on a policy that can be created and/or updated by the user, as described below with reference to FIG. 4. The policy can specify criteria for the token generator 320 for any of a wide variety of situations. For example, a policy can specify that if the user's email application requests a security token, the token generator 320 is to subsequently send the requested token using a particular pre-existing information card. In alternative embodiments, the policy can specify that the token generator 320 is to generate a self-issued token by passing certain claims, claim values, and cryptographic materials directly without generating a self-issued card.

FIG. 4 shows an exemplary embodiment of the disclosed technology operable to provide a user with policy configuration management capabilities. A client computer system 405 includes a receiver 410, a transmitter 415, and a policy configuration manager 420. The policy configuration manager 420 can provide a user with the ability to create, define, edit, update, store, and delete one or more policies 425 to which the user would have access.

Each policy 425 can include, for example, a list of relying party sites and specific information pertaining to each site. For example, a user can define the policy 425 such that every time the user visits the site, the user is automatically logged into the site (e.g., using a specified information card). Alternatively, the policy 425 can be defined such that every time the user visits the site, the user is automatically logged into the site without using a self-issued information card.

When the policy 425 is first established, there may be an initial requirement for a particular relying party to obtain certain key information (e.g., username or email address). After a period of time, however, the relying party may require additional pieces of information (e.g., phone number). The policy configuration manager 420 can be used to update the corresponding policy (or policies) in such a situation. In other words, the policy can be defined such that certain pieces of information are designated as being passable to the relying party but only when they are requested. This advantageous arrangement means that a user does not need to constantly revise a policy, even when the relying party's security policy changes.

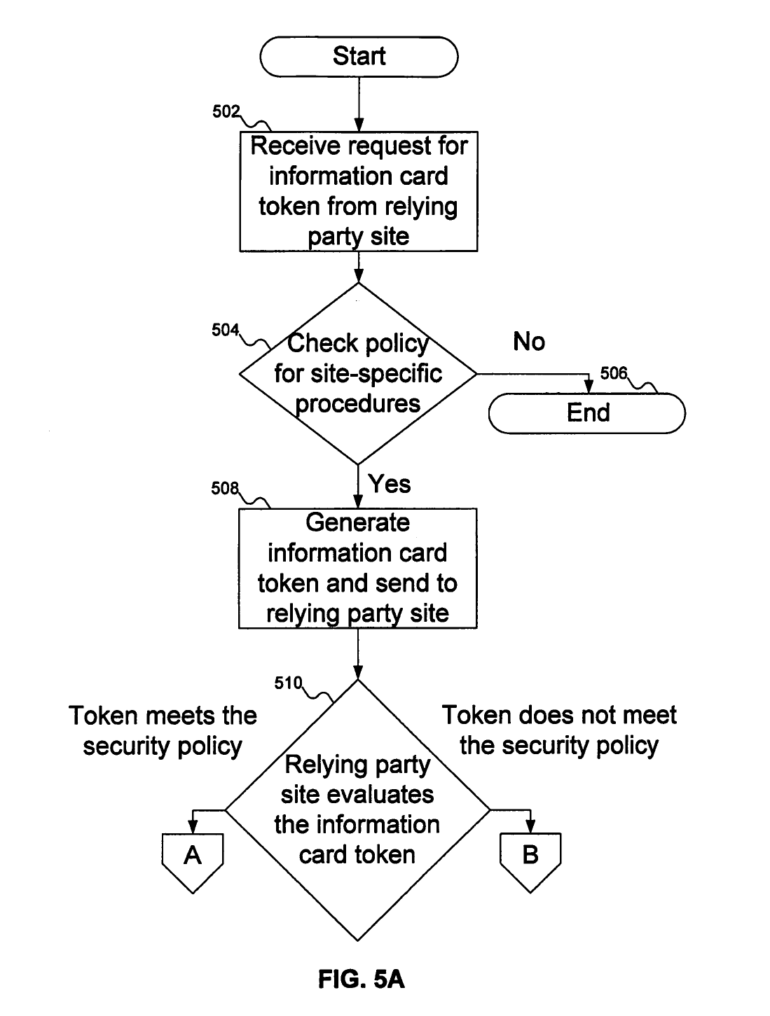

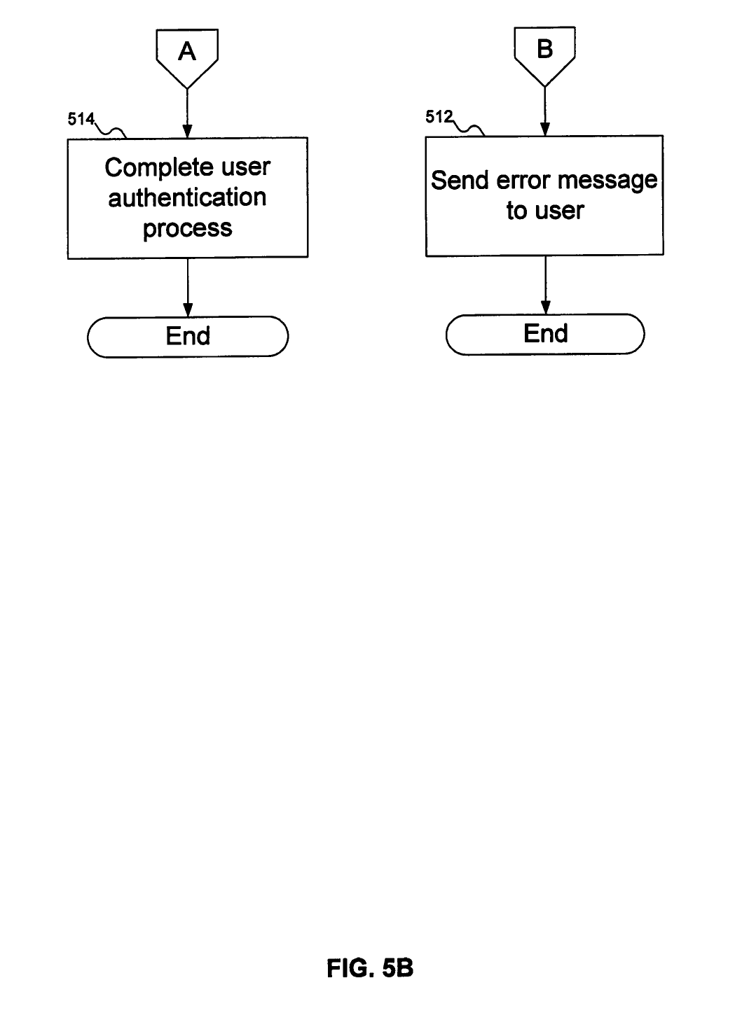

FIGS. 5A-5B show a flowchart of an exemplary procedure to generate a security token according to embodiments of the disclosed technology. In FIG. 5A at 502, a request for a security token (e.g., from a relying party site) is received by a user (e.g., at a client computer station). For example, the user may be visiting a site that requires user authentication such as a login procedure.

At 504, a policy is checked to see if there are any defined procedures for handling a security token request from the relying party site. If there are no defined procedures, processing stops (as shown at 506) and control can be handed to current token generation tools such as a user-interactive card selector, for example. If there are defined procedures for the relying party site, however, processing continues at 508.

At 508, a security token is generated based at least in part on the defined procedures in the policy. The generated security token can include, for example, claims (e.g., username/password), claim values, and cryptographic materials. Once generated, the security token is sent to the relying party site in response to the security token request. The security token is received and evaluated by the relying part site as shown at 510. If the security token does not meet the relying party site's security policy, an error message can be provided to the user as shown at 512 of FIG. 5B. At this point, processing can be directed to a current user-interactive card selector (not shown) so that the user can manually enter the possibly missing or out-of-date authentication information, for example. If the security token meets the relying party site's security policy, however, the user authentication is completed (as shown at 514 of FIG. 5B) and the user can begin using the site, for example.

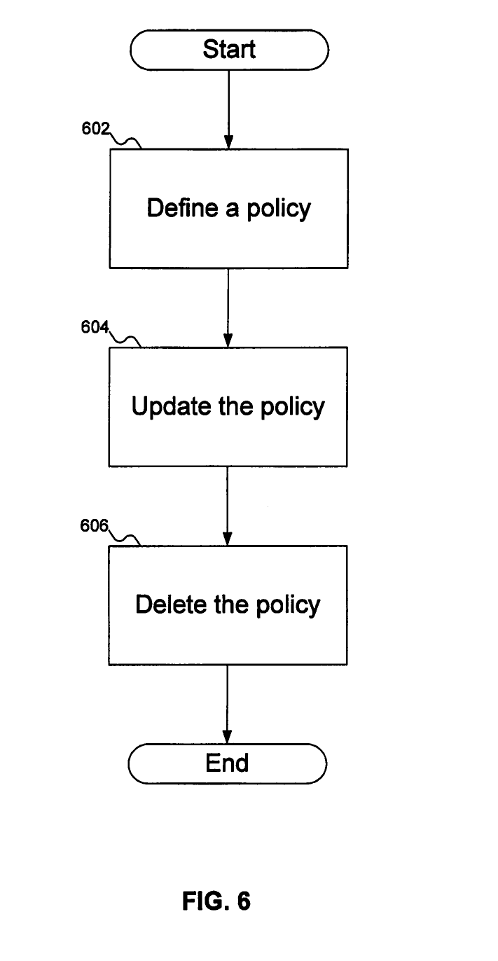

FIG. 6 shows a flowchart of an exemplary procedure to manage a policy according to embodiments of the disclosed technology. At 602, at least one policy is defined (e.g., by a user or automatically based on certain information). The policy may include information pertaining to one or more relying party sites. For example, a user can specify that when a particular site is visited, certain authentication information (e.g., claim type and claim values) is to be automatically passed to the site (e.g., as a generated security token) without any user interaction.

At 604, one or more policies are updated. For example, a user can add, edit, or delete authentication information pertaining to one or more relying party sites. If a user changes his or her name and/or password for a particular site, or if the site changes its security policy with respect to such login information (e.g., the site now requires longer usernames than it did previously or passwords containing both numbers and letters rather than just letters), the user can revise the policy or policies pertaining to the site in question such that the new login information is appropriately recorded. There are various other types of information in a policy that a user can update. For example, a user can update a policy such that only certain types of authentication information are to be provided to certain relying party sites (e.g., during only certain specified times).

At 606, one or more policies are deleted. If a user no longer desires to have a particular policy, or if a situation has arisen in which the user is no longer permitted to use certain policies, the policy or policies can be deleted in part or in whole (e.g., by the user directly or a third party, such as an IT manager).

While the policy configuration management and security token generation techniques described herein are generally services that are separate from a card selector application, either or both of the techniques can be used in connection with or even integrated into a card selector application (e.g., DigitalMe and Windows CardSpace) in certain embodiments of the disclosed technology.

In certain embodiments, the disclosed technology can be implemented as a policy-based browser add-on that can be used for authentication purposes (e.g., providing claim values to trusted sites) without requiring a user to interact with a card selector. Such a policy-based add-on advantageously provides a simple interface that can allow the user to specify a trusted web site and a set of claims to be automatically disclosed (e.g., upon request) to that site. For example, while visiting the site, the user can simply click on an “infocard login” button and, based on a pre-defined policy, the appropriate information would be subsequently released to the site in accordance with the policy. The identity selector would desirably not be presented to the user during this process.

In alternative embodiments, the disclosed technology can replace an interactive user interface (e.g., GUI) with a parameter-based command-line selector utility external to a card selector. Such a utility can advantageously provide a means whereby a process (e.g., a script or and application) can desirably request a security token without requiring any user interaction. A typical usage scenario can involve several parameters, such as information card, recipient, credentials, claims, and token type, all of which are discussed below.

Regarding the information card parameter, an information card can be provided in one of at least four different ways. First, if the user invoking a card selector has an existing card store, the card could be specified by its name or other identifier. Second, a managed card file could be passed by providing its path. Third, a roaming store file could be passed by providing its path, the decryption password, and a card name or other identifier. Fourth, if a self-issued token is required, the claim values and required cryptographic secrets (e.g., master key and hash salt) could be passed directly.

Regarding the other parameters that can be specified for command-line selector implementations of the disclosed technology, token type can be used to specify a certain token type (e.g., SAML). The remaining three parameters that can be applied are optional: recipient (that can be used to specify the URL of a relying party web site, for example), credentials (e.g., credentials needed to authenticate to a remote token provider), and claims (e.g., a list of claims that must be included in the returned token). Alternatively, a public key or certificate file could be specified as the recipient parameter.

Embodiments of the command-line utility can desirably follow the standard convention of returning a zero exit code, and the token could be passed back to the calling process via stdout or, optionally, written to a file, for example. When an error occurs during processing, the command-line utility can exit with a non-zero code and return error information via stdout, stderr, or a file, for example.

Embodiments of the disclosed technology can be used in conjunction with an open source information card selector (e.g., DigitalMe) implemented using a stack of components. For example, a person of ordinary skill in the art will recognize that exemplary implementations of the disclosed technology can include a user interface (e.g., Cocoa or GTK-based), an Identity Services System (ISS), and a cross-platform abstraction/toolkit.

In an example, consider a user having a sales office in Orlando, Fla., and a development office in Denver, Colo. Because of the different nature of business in each office, the policies set up by the user for the Orlando office differ greatly from the policies set up by the user for the Denver office. If the user orders something online from an Internet retailer, the user would understandably want the order shipped to the office from which he or she placed the order. Thus, in the example, the policies are desirably set up such that the shipping address information corresponding to the office from which the order was placed is advantageously automatically forwarded to the Internet retailer as part of the online transaction. In embodiments of the disclosed technology, the content of claim values (e.g., address information) can be varied but still used for identification and authentication purposes so long as the cryptographic keys are held constant.

In another example, consider a user who is responsible for system backups for his or her office. Because the user would prefer that the backups take place during the night (e.g., at a time when he or she is not in the office), the user can desirably set up a policy such that authentication for backup purposes is advantageously allowed only during the time period between 1 a.m. and 5 a.m., for example. Thus, during the day (e.g., when the user is likely in the office), any backups would not be automatically authenticated. Rather, a current tool such as an interactive pop-up would be used to require input from the user before proceeding with the backup.

The disclosed technology described herein provides various advantages that include, but are not limited to, providing a user with an ability to request or generate a security token without any user interaction required, providing a user with an ability to pass an information card file directly to a card selector without requiring a pre-loaded or pre-configured information card store, and generating a policy-based, self-issued security token by passing claims, claim values, and cryptographic materials directly without an intermediate step of generating a self-issued information card.

In current card selectors, a self-issued card must have been already created and added to a card store. In embodiments of the disclosed technology, however, a user can advantageously define in a policy various types of information (e.g., type of claim and claim values) to be included in a self-issued card as well as cryptographic material, all of which can be desirably passed to a security token service such that a security token can be generated based on the information provided, as opposed to a previously-created information card stored in an information card store. Thus, the disclosed technology desirably allows for real-time generation of self-issued cards, substituting the most appropriate values available at the time, as well as real-time generation of security tokens based on the authentication information provided. Furthermore, the authentication information desirably need not be stored in a policy as fixed values. Rather, the authentication information can desirably result from one or more formulas or some type of descriptive language in the policy that would advantageously allow values to be generated based on certain inputs.

The various advantageous techniques described herein may be implemented as computer-implemented methods. Additionally, they may be implemented as instructions stored on a tangible computer-readable medium that, when executed, cause a computer to perform the associated methods. Examples of tangible computer-readable media include, but are not limited to, disks (e.g., floppy disks, rigid magnetic disks, and optical disks), drives (e.g., hard disk drives), semiconductor or solid state memory (e.g., RAM and ROM), and various other types of tangible recordable media such as CD-ROM, DVD-ROM, and magnetic tape devices.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An apparatus, comprising:
a receiver on a machine, wherein the receiver is configured to receive a request from a relying party site for a security token;
a security token generator on the machine, wherein the security token generator is operable to automatically generate a security token in response to the request based at least in part on a policy; and
a transmitter on the machine, wherein the transmitter is configured to transmit the generated security token to the relying party site.

2. An apparatus according to claim 1, further comprising a policy configuration manager on the machine, wherein the policy configuration manager is operable to define the policy.

3. An apparatus according to claim 1, wherein the generated security token comprises a credential type and credential data.

4. An apparatus according to claim 3, wherein the credential type is username/password.

5. An apparatus according to claim 4, wherein the credential data comprises a username, wherein the username is specific to the relying party site, and a password, wherein the password is specific to the relying party site.

6. An apparatus according to claim 3, wherein the generated security token further comprises cryptographic material.

7. An apparatus according to claim 2, wherein the policy configuration manager is further operable to update the policy.

8. An apparatus according to claim 2, wherein the policy configuration manager is further operable to delete the policy.

9. An apparatus according to claim 1, wherein the policy specifies authentication information to be used by the security token generator in generating the security token, wherein the authentication information corresponds to a security policy at the relying party site.

10. A computer-implemented method of generating a security token responsive to an information card token request, comprising:
receiving an information card token request from a relying party site;
responsive to the information card token request, automatically generating an information card token based at least in part on a user-defined policy; and
transmitting the generated information card token to the relying party site.

11. A computer-implemented method according to claim 10, further comprising defining the user-defined policy.

12. A computer-implemented method according to claim 11, further comprising updating the user-defined policy.

13. A computer-implemented method according to claim 11, wherein defining the user-defined policy comprises adding authentication information to the user-defined policy, wherein the authentication information pertains to the relying party site.

14. A computer-implemented method according to claim 13, wherein adding the authentication information comprises adding username/password information.

15. A computer-implemented method according to claim 13, wherein generating the information card token comprises incorporating the authentication information into the information card token.

16. A computer-implemented method according to claim 15, wherein generating the information card token further comprises incorporating cryptographic material into the information card token.

17. A computer-implemented method according to claim 10, further comprising deleting the user-defined policy.

18. One or more computer-readable media storing instructions that, when executed by a processor, perform a computer-implemented method according to claim 10.

19. An article comprising a storage medium, the storage medium having stored thereon instructions that, when executed by a machine, result in providing authentication information to a relying party site, wherein the authentication information is based at least in part on a user-defined policy.

20. An article according to claim 19, wherein providing the authentication information comprises passing at least one claim, at least one claim value, and cryptographic information.
